(19) United States
(12) Patent Application Publication
(10) Pub. No.: US 2006/0222974 A1
(43) Pub. Date: Oct. 5, 2006

(54) Optical element with homeotropically aligned liquid crystal molecules, and a liquid crystal display using the optical element

(75) Inventors: Atsushi Suemasu, Tokyo (JP); Norihisa Moriya, Tokyo (JP)

Correspondence Address: KANESAKA BERNER AND PARTNERS LLP, SUITE 300, 1700 DIAGONAL RD, ALEXANDRIA, VA, 22314-2848, US

(73) Assignee: DAI NIPPON PRINTING CO., LTD.

(21) Appl. No.: 11/393,646

(22) Filed: Mar. 31, 2006

(30) Foreign Application Priority Data
Mar. 31, 2005 (JP) 105513/2005

(51) Int. Cl. C09K 19/00

(52) U.S. Cl. 430/20

(57) ABSTRACT

An optical element has a base material with an optically transparent base plate, and a refractive functional layer capable of refracting light that is laminated to the base material. The refractive functional layer has liquid crystal molecules fixed in homeotropic alignment, and the optical element has a haze of 0.1 or less. The optical element can be economically produced, and enables the production of LCD devices with improved contrast and reduced unevenness of colors.

### BACKGROUND OF THE INVENTION AND RELATED ART STATEMENT

The present invention relates to optical elements that contain double refractive index layers, and more specifically, to optical elements that have layers in which liquid crystal molecules are aligned and stabilized as double refractive-index layers.

Liquid crystal displays (LCD) are employed widely in televisions and medical devices because of the extreme thinness, light weight, and energy efficiency thereof, and because they are relatively free from flickering. On the other hand, according to the angle from which the user views the screen of the display, it may have some leakage of light and gradation reversal.

These side effects result in some unevenness of colors and poor contrasts, and there has also been a narrow angle of view to consider.

Some liquid crystal display devices have been proposed to solve these various problems. These devices have some optical elements that control the amount of light emitting from the liquid crystal cells as well as the light intruding into the liquid crystal cells.

In the case of these devices, the proposed optical elements employ films that are obtained by uniaxially or biaxially stretching triacetylcellulose (TAC) films, or layers in which liquid crystal molecules are aligned in a certain direction and stabilized.

Japanese Unexamined Patent Application Publication No. H05-142531 proposes a visual compensation film that consists of nematic liquid crystal polymers with a positive refractive-index number. It has chains of molecules aligned along the grain of the film surface.

In Japanese Unexamined Patent Application Publication No. H05-142531, it is stated that this visual compensation film has a vertical membrane coated with some chemical agents made of alkyl silicone and fluoroalkyl silicone on the surface of a glass plate, the cells are formed in this way, liquid crystal molecules are injected and sealed in the cells, and liquid crystal cells are obtained through optical polymerization.

Japanese Unexamined Patent Application Publication No. 2002-174724 proposes a method of producing liquid crystal layers that contain homeotropically treated liquid crystal compounds.

These layers are produced by coating the vertical membrane formed on the plate with the polymerized liquid crystal compounds.

According to this method, long chain alkyl type dendrimer derivatives are used as the chemical that induces the vertical membrane to form.

Furthermore, in the same document, it is stated that, by the same method, a film material containing the liquid crystal layers in homeotropic alignment is obtained, and that this film material has a possible use as an optical film, such as a phase difference film.

Some methods of production of liquid crystal films in homeotropic alignment are proposed in Japanese Unexamined Patent Application Publication No. 2002-174725.

On a plate without vertical membranes, a monomer unit containing liquid crystal fragment side chains and a monomer unit containing non-liquid crystal fragment side chains are sprayed, and after aligning this particular liquid crystal polymer homeotropic alignment, the film is produced by maintaining this alignment on the plate.

A method of producing the liquid crystal film in homeotropic alignment is introduced in Japanese Unexamined Patent Application Publication No. 2003-121852.

After forming a binder layer and then an anchor coat layer on a plate without perpendicular membranes, a side chain liquid crystal polymer is applied on the anchor layer and put in homeotropic alignment, and the liquid crystal film homeotropic alignment is produced by keeping that alignment in this condition.

This method employs a side chain liquid crystal polymer that can form a liquid crystal layer in homeotropically alignment on the surface of the plate without perpendicular membranes.

However, the visual compensation film in Japanese Unexamined Patent Application Publication No. H05-142531 is obtained by a series of processes. First, by forming cells with two plates containing aligned membranes, then by injecting and sealing liquid crystal molecules in those cells, aligning these molecules vertically, and keeping them in this state while optically polymerizing the molecules.

This visual compensation film in Japanese Unexamined Patent Application Publication No. H05-142531 is obtained only after a number of differentprocesses as seen here, so the cost of production may increase. This has been a problem. In addition, the visual compensation film, as a film material, needs to be stabilized on a liquid crystal display device by some type of adhesive, and it is necessary to determine a specific adhesive in order to optimize the contrast of the display device.

In the method introduced in Japanese Unexamined Patent Application Publication No. 2002-174724, when producing a liquid crystal layer in homeotropic alignment by setting vertical membranes on the base plate, it is necessary to use a special material called long chain alkyl dendrimer derivatives. However, with the method above, the production cost becomes extremely high. This could be a problem.

According to the method described in Japanese Unexamined Patent Application Publication No. 2002-174725, to obtain liquid crystal film in homeotropic alignment, the film will consist of side chain polymers. Even when the homeotropic alignment thereof is maintained, liquidity will increase as the temperature rises. The double refractive characteristics thereof can easily be affected by heat. For this reason, the temperature range, within which an ideal double refractive characteristic can be maintained, is relatively small, and the alignment of the liquid crystal polymer on the coated part may be uneven.

Therefore, liquid crystal film homeotropic alignment obtained in this way cannot be employed in LCD devices that should be able to withstand high-temperature heat.

The range of LCD use is limited for this liquid crystal film. Furthermore, this method is affected by the same type of problems mentioned in Japanese Unexamined Patent Application Publication No. H05-142531.

In addition, when applying liquid crystal film in homeotropic alignment on LCD devices, it is absolutely necessary to avoid conditions of high-temperature heat, so it is particularly difficult to place this film inside LCD devices.

For this reason, liquid crystal film in homeotropic alignment obtained according to the method in Japanese Unexamined Patent Application Publication No. 2002-174725 has a problem in terms of the range of possible use, which is quite limited.

According to Japanese Unexamined Patent Application Publication No. 2003-121852, liquid crystal film in homeotropic alignment thus obtained is made of liquid crystal polymers of a side chain type. Therefore, it has the same problems as those mentioned in Japanese Unexamined Patent Application Publication No. 2002-174725. Furthermore, this method inherits the same problems as those in Japanese Unexamined Patent Application Publication No. H05-142531 as well.

The present invention has been created in order to solve the problems mentioned thus far above. In addition to keeping production cost low, the invention makes it possible to produce LCD devices with improved contrast, and the purpose thereof is to provide optical elements that make it possible to produce LCD devices with reduced unevenness of colors.

Further objects and advantages of the invention will be apparent from the following description of the invention and the associated drawings.

### SUMMARY OF THE INVENTION

According to an embodiment of the present invention, (1) the basic material is equipped with a base plate that has optical permeability, optical elements layered with a double refractive function layer, which enables light to double refract, haze under 0.1, a double refractive function layer that is a layer formed by stabilizing liquid crystal molecules in homeotropic alignment.

And (2), the double refractive function layer has perpendicularly aligned membranes that enable the liquid crystal molecules to form in homeotropic alignment, and the double refractive index layer is set on the perpendicularly aligned membranes. The double refractive index layer is a layer that has polymerized liquid crystal molecules on the edges thereof, maintaining homeotropic alignment.

According to the optical elements mentioned above in (1), there is (3) a double refractive index layer that dries under air pressure on the base plate coated with layer forming liquids including liquid crystal molecules, and it is a layer formed by bridging these plates to stabilize in homeotropic alignment.

According to the optical elements mentioned above in (2), there is (4) a color layer equipped with pigments formed in at least one position between the exterior and the base of the optical elements, and the refractive index function layer. This is characteristic of optical elements mentioned in either one of (1) and (3) above.

According to another aspect of the invention (5), inside the LCD device material composed of layers of liquid crystal by injecting liquid crystal between two layer parts, which are equipped with layers that have optical permeability, there is in at least one of the layer parts, layers made of the optical elements mentioned in one of (1) and (4).

According to LCD material with the characteristic thereof being formed likewise (6), there are optical elements, characterized as having the double refractive index layer formed between the base plate and the liquid crystal layer, and LCD device materials, as stated in (5).

According to another embodiment of the invention (7), there are in multi-layered LCD devices, formed, in addition to being equipped with layers made of polarizer plates on both sides of the liquid crystal layers, by equipping with layers made of electrodes that change the direction of the electric current by loading electric pressure LCD devices made from the materials mentioned in (5) or (6).

The optical element of this invention has a layer with liquid crystal molecules stabilized in homeotropic alignment, as well as a haze of under 0.1, and an improved optical permeability. Therefore, this element has, towards the thicker part, a reduced rate of refraction index, so it can control the diffusion of light passing through (the elements).

The optical element of this invention can be used to control the phase difference, optical compensation elements, and polarization of light because it maintains homeotropic alignment. As stated above, it can control the diffusion of light, so it is an element with finer capabilities to control phase differences more precisely.

With this optical element, it is possible to manufacture LCD devices that can reduce light leakage, and LCD devices with less unevenness in color and with better contrast.

This optical element can be used in optical devices to be used in relatively hot areas such as inside an automobile. Because the double refractive index layer thereof has a bridged construction, its double refractive property is resistant to heat. Furthermore, because of its high heat resistance, it can be used inside LCD panels of optical devices.

Furthermore, this optical element will make it possible to form layers in one amalgamated form inside the LCD panel component, and in a separate entity, it is possible to design optical devices without setting up some film-like materials to control the phase differences (phase difference control member).

The optical element of this invention makes it possible to make thinner LCD devices by creating pigment layers and using them in the devices, because it eliminates the necessity of having Phase Difference Control components, separate from the component containing the pigment layers.

The optical element of this invention is used as one element equipped with a double refractive index layer with a haze of under 0.1, because it is possible to manufacture vertical membranes by coating the base part with a membrane-forming liquid and double refractive index layer liquid on top of that, dried naturally under air pressure, aligning the liquid crystal, and bridging the liquid crystal. It is a relatively simple process, so it is easier to keep costs low.

LCD device components with this optical element make it possible to enhance phase difference control capabilities and to produce LCD devices that have characteristics of optical elements such as the reduction of light diffusion due to adhesives.

Furthermore, LCD devices with this optical element make it possible to design thinner displays and wider angles of view, and to improve contrast as well as to control better color unevenness on the displays.

### BRIEF DESCRIPTION OF THE DRAWINGS

FIG. 1 is a diagrammatic figure showing a cross-sectional structure of an optical element according to the present invention.

FIG. 2(a) is a diagrammatic figure showing a cross-sectional structure of an optical element equipped with a functionality layer in a base plate. FIG. 2(b) is a diagrammatic figure showing a cross-sectional structure of another embodiment of an optical element equipped with a functionality layer in a base plate.

FIG. 3 is a diagrammatic figure showing a cross-sectional structure of an optical element laminated with a more functional layer.

FIG. 4(a) is a diagrammatic figure showing a cross-sectional structure of an optical element equipped with a coloring layer. FIG. 4(b) is a diagrammatic figure showing a cross-sectional structure of another embodiment of an optical element equipped with a coloring layer. FIG. 4(c) is a diagrammatic figure showing a cross-sectional structure of still another embodiment of an optical element equipped with a coloring layer.

FIG. 5(a) is a diagrammatic figure showing an LCD member equipped with an optical element according to the first embodiment of the invention. FIG. 5(b) is a diagrammatic figure showing the LCD member that forms the optical element of the first embodiment in such a way that the refractive index layer is positioned between the base plate and a liquid crystal layer.

FIG. 6 is a diagrammatic figure showing an LCD member equipped with an optical element according to a third embodiment of the invention.

FIG. 7(a) is a diagrammatic figure showing an LCD according to a first LCD embodiment. FIG. 7(b) is a diagrammatic figure showing an LCD according to a second LCD embodiment.

### DETAILED DESCRIPTION OF THE PREFERRED EMBODIMENTS

The following is a detailed explanation of a first property of an optical element according to the invention.

According to a first embodiment of the invention, the optical element 1(1a) has a haze under 0.1, and it consists of a base part 2, which contains light permeability, and of a double refractive index function layer inside the base part 2.

In the embodiment, a double refractive index function layer is one that has the vertical membrane 3 that gives an aligning property to the liquid crystal 5 in proximity, and it has a double refractive index layer 4 that is mounted on the vertical membrane 3. An explanation is given below with reference to the drawings.

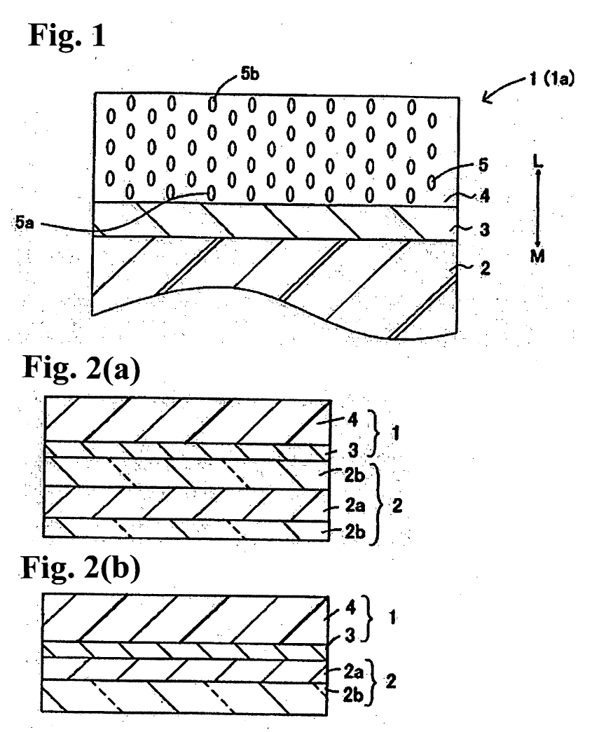

FIG. 1 is a simple visual explanation for the optical element in sectional view.

The haze rate of the optical element 1 is the value of the optical element measured towards its thicker part. It is measured according to the JIS K 7136 standard.

The base part 2 has a base plate 2 that has a light permeability, and it can be made up of a single plate layer structure, or a multi-layered structure, or it can be made by layering the functionality layer 2b, which has some required elements, on top of the base plate 2.

For the base part 2, it is possible to have functionality layers 2b on both sides of the base plate 2, or on one side (FIGS. 2(a) and 2(b), respectively), and one with a functionality layer inside the base plate 2 is possible as well.

For the base plate 2, it is preferable to have a plate that has an optically equal isotropy, but it is also possible to have a partially shaded area.

Furthermore, the rate of light permeability of the base plate 2a can be selected accordingly.

For the base plate 2a, in addition to a glass base plate, various materials can be used. In specific cases, plastic materials such as polycarbonate, polymethyl methacrylate, polyethylene terephthalate, and triacetylcellulose are used, and films such as polysulfone, polypropylene, polyimide, polyamideimide, and polyetherketone could be used.

When using the optical element for LCDs, a non-alkali glass is preferable for the base plate. Furthermore, for the film for the plate, it is possible to use uniaxially or biaxially stretched films.

Moreover, inside the film material, triacetylcellulose (TAC) film could be used.

The functionality layer 2b is a layer with a property that can change the condition of light, and it is different from the double refractive index layer 4.

Some examples are horizontal membranes that align liquid crystal molecules horizontally, and vertically aligned membranes that align the molecules vertically.

In addition, the functionality layer 2b is mounted not only on the entire surface of the base plate 2a but also partially on portions thereof.

Using a membrane forming liquid that includes polyimide, the vertically aligned membrane 3 is formed by coating the membrane forming liquid by means of flexo printing or spin coating and hardening it.

Liquid containing polyimide specifically includes Nissan Chemical's SE-7511 and SE-1211, or JSR's JALS-20210R2.

Polyimide that makes up a vertical membrane 3 is preferably one that contains a long-chain alkyl base, because this makes it possible to have a wide selection of thicknesses of the double refractive index layer 3, which consists of the optical elements.

The thickness of the vertically aligned membrane 3 is preferably 0.01 to 1 μm. If it is thinner than 0.01 μm, it is difficult to align the liquid crystal in homeotropic alignment. Furthermore, if it is thicker than 1 μm, the vertically aligned membrane will reflect light randomly, and the light permeability rate of the optical elements is thereby significantly reduced.

In this demonstration, for the vertically aligned membrane, one formed with polyimide is used as an-example, but it is also possible to use certain surfactants and coupling agents.

In case some surfactants and coupling agents are used to form the vertically aligned membrane, if the surfactant can align the polymerized liquid crystal in a stick-like form in homeotropic alignment, there will be no problems, except that it is necessary to heat it to a temperature wherein liquid crystals change into crystal phase, so these surfactants and coupling agents that form the vertically aligned membranes heated along with the double refractive index layers must have heat resisting properties that can withstand this type of temperature.

Furthermore, when forming the double refractive index layer, the liquid crystal is melted in some organic agent, so the surfactants and coupling agents that form the vertically aligned membranes that border on the double refractive index layer should be ones that work well with organic agents that melt the liquid crystal.

If these agents are used, the surfactants are not limited to non-ion, cation, or anion types, and it is possible to use only one type of surfactant at a time, or several types at the same time. The same is true for the coupling agents.

Regarding the surfactants, it is preferable to have one that is water-repellent or oil repellent in order to put the polymerized liquid crystal in homeotropic alignment even when increasing the thickness of the double refractive index layer 4. For example, the surfactant possesses (a) alkyl chain or long alkyl chain, (b) alkyl chain or long alkyl chain and its portion of the alkyl chain or the long alkyl chain is replaced with fluorine, (c) a surfactant having a side chain, or one in whose side chain a fluoride atom is also included.

In some particular cases, surfactants with excellent water or oil repellency are (i) lecithin, (ii) octadecildimethyl (3-trimetoxicipro)ammonium chloride, (iii) hexadecilamin, (iv) Academin 4DAC-85 (surfactant, product of Asahi Denka-Kogyo), (v) Doraipon 600E (surfactant, product of Nikka Kagaku), and (vi) NK Guard NDN Z-7 (also Nikka Kagaku).

Specifically, the coupling agents include silane coupling agents that can be obtained by means of hydrolysis of silane compounds such as n-octyl trimethoxysilane, n-octyl triethoxysilane, decyl trimethoxysilane, decyl triethoxysilane, n-dodecyl trimethoxysilane, n-dodecyl triethoxysilane, octadecyl trimethoxysilane, octadecyl triethoxysilane.

Those that can more solidly align the liquid crystal molecules in homeotropic alignment are silane-based fluoride coupling agents that can be obtained by hydrolysis.

As seen in FIG. 1, a double refractive index layer 4 has a structure of bridged high molecules, formed by aligning the thin and elongated molecules of the liquid crystal 5, and linking the molecules of the liquid crystal 5 together.

Furthermore, in FIG. 1, for the sake of brevity, the portion that shows the linkage of the molecules of the liquid crystal 5 is omitted.

Ideally, the double refractive index layer 4 should be more than 80 degrees in terms of the bridging of the molecules of the liquid crystal 5, and more preferably 90 degrees. If it is less than 80 degrees, it tends to be difficult to align evenly.

As for the Double Refractive Index Layer 4, regarding the tilt angle of the molecules of the liquid crystal 5, which is a unit that makes up the high bridging molecule structure, the tilt angle of the liquid crystal molecule (5a, for example) that is in the closest position to the vertically aligned membrane 3 of the Double Refractive Index Layer 4, and the tilt angle of the liquid crystal molecule (5b) that is farthest in the direction of the double refractive index layer (as indicated by the arrows L and M), in respect to the position of the liquid crystal (5a) molecule are equal.

In such a case, the tilt angle of the molecules of the liquid crystal 5 in the double refractive index layer 4 is even along the direction of its thickness. Furthermore, it is preferable to keep even each one of the tilting angle of the molecules of the liquid crystal 5 in the double refractive index layer 4, along the direction of its thickness.

Some retardation of the double refractive index layer 4 is caused in respect to the light coming into the layer due to the anisotropic property of the refraction of the molecules of the liquid crystal 5 that comprises it.

Retardation is the difference between the normal light and the abnormal light that occurs in reaction to the incoming light.

The size is obtained as the sum of the refraction Δn (the difference between no and ne) and d (the thickness of the double refractive index layer 4) if the index of the normal light is no, and that of the abnormal light is ne.

Therefore, for the double refractive index layer 4, it is possible to control the direction of the alignment of the molecules of the liquid crystal 5 and the degree of retardation by choosing according to the type of the molecules of the liquid crystal 5, the degree of the alignment of the liquid crystal molecules, and the thickness of the double refractive index layer 4.

The Double Refractive Index Layer 4 is formed on top of the vertically aligned membrane 3. If the molecules of the liquid crystal 5 are in proximity to the vertically aligned membrane 3, they are in a strong homeotropic alignment, so the double refractive index layer 4 is structured so that its retardation rate toward its thickness is small, such as under 1 nm.

Furthermore, if the molecules of the liquid crystal 5 are distant from the vertically aligned membrane 3, the homeotropic alignment is weak. Therefore, once the molecules that are distant from the membrane are in homeotropic alignment, the tilting angle of the crystal molecules of the double refractive layer index is even and in homeotropic alignment.

In attempting to have the molecules evenly aligned in homeotropic alignment, the retardation rate should ideally be under 1 nm, and even more preferably 0.01 nm, and most preferably closer to 0 nm.

The thickness of the double refractive index layer 4 is chosen according to the range within which it is possible to align the molecules of the liquid crystal 5 in homeotropic alignment, specifically within a range in which the retardation rate is under 1 nm. A rate of 0.1 nm is more preferable.

The molecules of the liquid crystal 5 that comprise the double refractive index layer 4 have an unsaturated double crystallization within their molecule structure, and they are capable of being linked in liquid crystal state (or liquid crystal that can be polymerized).

Furthermore, the molecules of the liquid crystal 5 should ideally have a double refraction Δn of 0.03 to 0.20, more preferably 0.05 to 0.15. Specific examples of such liquid crystal molecules are shown in the following formulae from 1 to 11.

In terms of heat resistance, it is ideal to have one that can be bridged in three dimensions, and one that has more than two unsaturated double crystallizations on the edges of the molecules used.

As for the molecules of the liquid crystal 5 that make up the double refractive index layer, several types of chemical compounds shown in the formulae 1 to 11 can be selected.

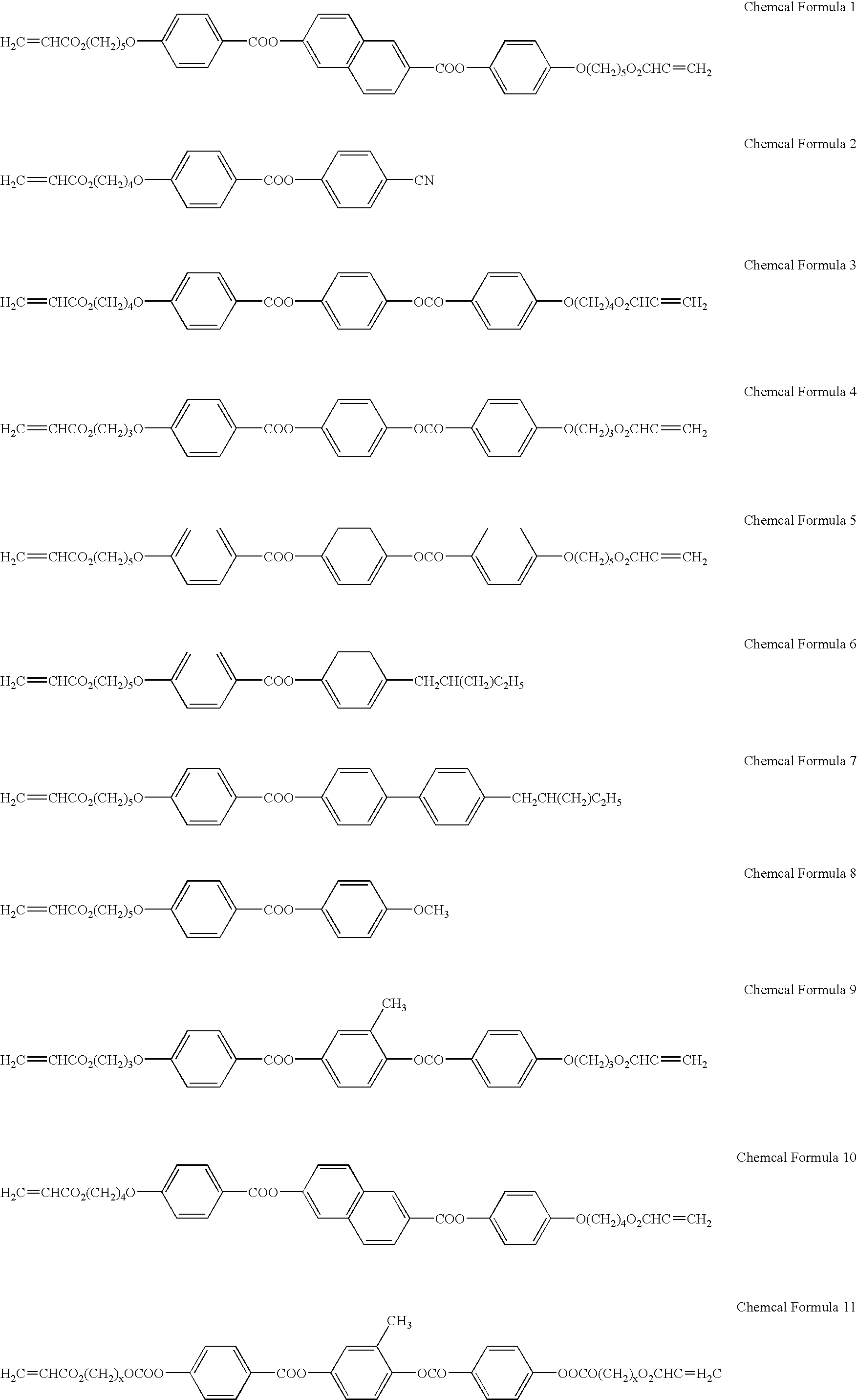

In this embodiment, in the coated film that is formed to be a vertical membrane using composition liquid for forming a double refraction index layer, which includes the above-mentioned liquid crystal 5 molecules, solvent and polyimide, the double refraction index layer 4 is formed by cross-linking the liquid crystal 5 molecules with each other while maintaining a state wherein the liquid crystal molecules contained in the coated film are aligned.

Furthermore, the double refraction index layer 4 can be formed by patterning on the perpendicularly oriented film 3 using various printing methods and a photolithographic method.

For the polyimide contained in the double refraction index layer, one that is the same as the polyimide contained in the film constituent humor in forming the perpendicularly oriented film 3 is used.

There is no limitation for the solvent as long as it dissolves the liquid crystal, and various organic solvents such as toluene can be used. However, when coating the constituent humor for double refraction index layer, it is preferable for the solvent to be able to coat the perpendicularly oriented film 3 with an even thickness.

The blending quantity for the liquid crystal 5 molecules in the constituent humor for double refraction index layer varies depending on the coating method, film thickness, type of solvent, etc., but it is preferable to be in the range of 10-50 wt %.

The constituent humor for the double refraction index layer has the blending ratio of polyimide with an alkyl group in the lateral chain and liquid crystal that is 1:7 to 1:3 at the weight ratio. Moreover, the blending quantity of the polyimide in the constituent humor for the double refraction index layer is preferably 12.5-25 wt % for the total amount of the polymerizable liquid crystal, and more preferably 15-22.5 wt %. If the blending quantity of the polyimide is less than 12.5 wt %, it can be difficult to obtain a composition of double refraction index layer homeotropically aligned sufficiently and evenly. If the blending quantity of the polyamide is greater than 25 wt %, the transmission factor of the light may decrease.

In addition, a photo-initiator or sensitizer can be added to the constituent humor for the double refraction index layer, if necessary.

For photo-initiators, there are benzil (or bibenzoyl), benzoin isobutyl ether, benzoin isopropyl ether, benzophenone, benzoylbenzoic acid, benzoylbenzoic acid methyl, 4-benzoyl-4′methyl diphenyl sulphide, benzylmethyl ketal, dimethyl aminomethyl benzoate, 2-N-butoxyethyl-4-dimethyl amino benzoate, p-dimethyl amino isoamyl benzoate, 3,3′-dimethyl-4-methoxybenzophenone, methyl benzoylformate, 2-methyl-l-(4-(methylthio) phenyl)-2-morpholino propane-1-on, 2-benzil-2-dimethyl amino-1-(4-morpholino phenyl)-butane-1-on, 1-(4-dodecyl phenyl)-2-hydroxy-2-methyl propane-1-on, 1-hydroxycyclohexyl phenyl ketone, 2-hydroxy-2-methyl-1-phenyl propane-1-on, 1-(4-isopropyl phenyl)-2-hydroxy-2-methyl propane-1-on, 2-chlorothioxanthone, 2,4-diethylthioxanthone, 2,4-diisopropylthioxanthone, 2,4-dimethylthioxanethone, isopropylthioxanthone, 1-chloro-4-propoxythioxanthone, etc., for example.

If a photo-initiator is blended in the constituent humor for the double refraction index layer, the blending quantity of the photo-initiator is 0.01-10 wt %. Furthermore, it is preferable that the blending quantity of the photo-initiator is a degree that does not impair the orientation of the liquid crystal molecules, and it is also preferably 0.1-7 wt % considering this point, and more preferably 0.5-5 wt %.

Moreover, if a sensitizer is blended in the constituent humor for the double refraction index layer, the blending quantity of the sensitizer can be accordingly selected in a range that does not impair the orientation of the liquid crystal molecules, and can be selected in the range of 0.011 wt %, to be more precise.

Additionally, the photo-initiator and sensitizer can be used alone respectively, or can be used with more than one type thereof.

In this embodiment, an optical element 1 can be produced as shown below.

First, film constituent humor containing polyimide is prepared using the material described above, and a coated film for perpendicularly oriented film is created by applying it on the surface of the base material with optical transparency by flexographic printing or spin coat, and moreover, a perpendicularly-oriented-film-forming base material with the perpendicularly oriented film formed on the base material by hardening this coated film for perpendicularly oriented film.

Subsequently, liquid crystal that is polymerizable liquid crystal and polyimide is dissolved in a solvent to prepare a constituent humor for the double refraction index layer, and this is applied on the perpendicularly-oriented-film-forming base material to create a coated film double refraction index layer.

This constituent humor for double refraction index layer is applied on the base material by various printing methods such as dye coating, bar coating, slide coating, roll coating, etc., and a method such as spin coating, and a coated film for double refraction index layer is formed by drying the base material applied with the constituent humor for double refraction index layer. At this time, the base material applied with the constituent humor for double refraction index layer is naturally dried under atmospheric pressure.

Furthermore, if the water repellency and oil repellency of the surface of the perpendicularly-oriented-film-forming base material are strong, the property of the surface of the perpendicularly-oriented-film-forming base material for applying the constituent humor for double refraction index layer can be made stronger in advance by having UV cleaning or plasma treatment in a range suitable to homeotropically align the liquid crystal.

Subsequently, the liquid crystals contained in the coated film for double refraction index layer are homeotropically aligned as shown below, for example.

In other words, the liquid crystals are homeotropically aligned by heating the coated film for the double refraction index layer to make the temperature of the coated film for the double refraction index layer higher than the temperature at which the liquid crystal in this coated film becomes a liquid crystal phase (liquid crystal phase temperature) and lower than the temperature at which the liquid crystal in this coated film becomes an isotropic phase (liquid phase.) The heating method of the coated film for the double refraction index layer at this time is not particularly specified, and it can be placed under a heating atmosphere or heated with infrared ray radiation.

In addition, for the method to homeotropically align the liquid crystal, it is possible to dry the coated film for the double refraction index layer under reduced pressure according to the condition of the liquid crystal contained in the coated film for double refraction index layer and this coated film, and also to load an electric field and magnetic field on the coated film for the double refraction index layer from the designated direction as well as the method described above.

If the liquid crystals are homeotropically aligned by drying the coated film for the double refraction index layer under reduced pressure, the coated film for double refraction index layer can be in a supercooled state by the reduced pressure, and this coated film can be further cooled to room temperature while maintaining the liquid crystal in the coated film for the double refraction index layer in the state of homeotropic alignment. Therefore, the liquid crystal can be effectively maintained in the state of homeotropic alignment until the cross-linking reaction of the liquid crystal.

The liquid crystal homeotropically aligned in the coated film for the double refraction index layer undergoes a cross-linking reaction as shown below, and an optical element is produced.

This cross-linking reaction is preceded by applying the light of the photosensitive wavelength of the liquid crystal on the coated film for double refraction index layer.

At this time, the wavelength of the light applied on the coated film for double refraction index layer is accordingly selected depending on the type of the liquid crystal contained in this coated film. Moreover, the light applied on the coated film for the double refraction index layer is not limited to a homogeneous light, and can be a light with a constant wavelength band including the photosensitive wavelength of the liquid crystal.

For the cross-linking reaction of the liquid crystal, it is preferable to cause a cross-linking reaction by heating the coated film for the double refraction index layer to a temperature of 1-10° C. lower than the temperature at which the liquid crystal changes from the liquid crystal phase to the isotropic phase. By doing so, the disturbance of the homeotropic alignment of the liquid crystal can be reduced during this cross-linking reaction. Furthermore, from this perspective, it is preferable that the temperature for cross-linking reaction be 3-6° C. lower than the temperature at which the liquid crystal changes from the liquid crystal phase to the isotropic phase.

Additionally, the cross-linking reaction of the liquid crystal can be caused by a method of applying a photosensitive wavelength light to the liquid crystal on the coated film while heating the coated film for the double refraction index layer to the liquid crystal phase temperature in an inert gas atmosphere (Method A) in addition to the method described above.

In Method A, the liquid crystal is cross-linked under an inert atmosphere, and the disturbance of the homeotropic alignment of the liquid crystal molecules located distant from the perpendicularly oriented film is inhibited compared to when the liquid crystal is cross-linked in an air atmosphere.

The cross-linking reaction of the liquid crystal can also be caused by a method of partially causing the cross-linking reaction (partial cross-link process) by applying a photosensitive light wavelength to the liquid crystal while heating the coated film for the double refraction index layer to the liquid crystal phase temperature. After the partial cross-link process, the coated film for the double refraction index layer is cooled to a temperature at which the liquid crystal reaches the liquid crystal phase (Tc), and is furthermore subjected to the photosensitive wavelength light in this condition to cause the cross-linking reaction to progress to completion (Method B.) Additionally, Tc described above is the temperature at which the liquid crystal reaches the liquid crystal phase in the coated film for double refraction index layer before causing the cross-linking reaction.

In the partial cross-link process, even though the coated film for double refraction index layer is cooled to temperature Tc, the cross-linking reaction progresses to the degree that the homeotropic alignment of the liquid crystal contained in that coated film is maintained. Therefore, the degree of progress of the cross-linking reaction in the partial cross-link process is accordingly selected depending on the type of the liquid crystal in the coated film for double refraction index layer and the thickness of the coated film, but it is preferable to advance the cross-linking reaction until the degree of cross-linking of the liquid crystal is about 5-50 in the partial cross-link process.

Method B can be performed under an inert gas atmosphere or air atmosphere, but it is preferable to perform the process under an air atmosphere from the perspective that it simplifies the equipment for implementing the process for the cross-linking reaction, and reduces the cost of producing the optical element.

Assuming xyz Cartesian coordinates to be in the thickness direction of this double refraction index layer 4 as the z-axis, the refractive index nx in the x-axis direction and the refractive index ny in the y-axis direction are almost equal in value, and the refractive index nz in the z-axis direction can be made larger than the refractive indexes nx and ny, because the double refraction index layer 4 has a cross-linked polymerized structure while maintaining a condition in which the liquid crystal 5 is homeotropically aligned in this optical element 1.

Therefore, the optical element 1 can make the double refraction index layer 4 a phase with a double refractive index property that the refractive index is nz>nx=ny, or in other words, a phase with the monopodial double refractive index property as well as the light axis in that thickness direction (the z-axis direction) and make it function as a so-called “+C plate” and a member with a function to control phase differences that can have optical compensation for the retardation of the light.

This optical element 1 has haze less than 0.1 as well as a phase in which the molecules of the liquid crystal are fixed in a state of homeotropic alignment.

Therefore, this optical element improves the transparency of the thickness direction, and the occurrence of noncontiguous parts of the refractive index in the thickness direction of the optical element is inhibited, and the scattering of light that goes through the optical element in the thickness direction is inhibited.

The optical element of this invention can be used as an element for inhibiting the polarization state of light such as an element for controlling the phase differences and optical compensation element, etc., because it fixes the liquid crystal in a state of homeotropic alignment, and taking it with inhibiting the scattering of light described above, it is an element that functions to accurately control the phase differences. Hence, according to this optical element, a liquid crystal display device that can more accurately reduce light leakage can be produced, resulting in the production of a liquid crystal display device that has a larger view angle and better contrast and controlled color shading of a liquid crystal display screen.

If the double refraction index layer 4 has a cross-linked structure, this optical element 1 has a double refraction property that is not easily affected by heat.

This optical element 1 can form the double refraction index layer 4 through a relatively simple process that is to apply film constituent humor on the base material 2 to create the perpendicularly oriented film 3, also to apply the constituent humor for the double refraction index layer on the film and to orient the liquid crystal to cross-link the liquid crystal, and therefore the production cost is easily reduced.

This optical element 1 has the double refraction index layer 4 formed with the constituent humor for double refraction index layer containing the component contained in the film constituent humor for forming the perpendicularly oriented film 3. Therefore, the optical element 1 can put the double refraction index layer 4 in a state in which the degree of the homeotropic alignment of the liquid crystal 5 molecules apart from the perpendicularly oriented film 3 is made close to the degree of the homeotropic alignment of the contiguous liquid crystal 5 molecules to the perpendicularly oriented film 3, and is also able to create a state in which the liquid crystal is more evenly homeotropically aligned in the thickness direction of the double refraction index layer 4.

According to this optical element 1, the liquid crystal panel can be integrally formed by laminating the member comprising the panel, and optical equipment can be designed without providing a member to control the phase differences in a separate body.

The optical element of this invention can function to change the light conditions on at least one face of the outer surface and the basal plate, surface of the optical element in the first configuration, and has layers of functionality different from the double refraction index layer that are stacked (the second configuration.)

For the optical element in the second configuration, an example of the layers different in double refractive index property from the double refraction index layer formed on the outer surface of the optical element in the first configuration as a functional layer is described.

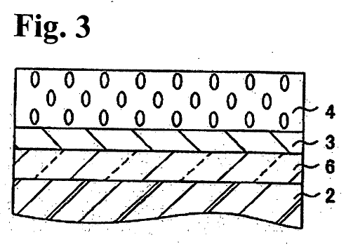

This optical element is formed with a functional layer 6 located between the basal plate 2 and double refraction index layer 4 as shown in FIG. 3.

In this case, in the optical element of the second configuration, a layer different in double refractive index property as the functional layer 6 (different double refraction index layer) has a different double refractive index property from the double refractive index property (+C plate) of the double refraction index layer in the first configuration.

Specifically, the different double refraction index layer can be a layer with the double refractive index property that the refractive index described above is nz=nx<ny or nz=ny<nx, in other words a layer that functions as an “+A plate,” and also be a layer with a double refractive index property in which the refractive index described above is nz<nx=ny, in other words a layer that functions as “−C plate.”

Additionally, the layer that functions as the so-called “+A plate” described above can be obtained by forming the coated film for forming a horizontally oriented film on the base material surface or double refraction index layer with plastic materials, etc., that can horizontally align the liquid crystal, obtaining the horizontally oriented film by applying rubbing treatment or light orienting treatment on the surface of the coated film for forming horizontally oriented film, and coating the solution in which the liquid crystal is dissolved in a solvent on the horizontally oriented film to fix it in a state of homogeneous alignment.

Moreover, the layer that functions as the so-called “−C plate” described above can be formed by coating the solution obtained by dissolving the liquid crystal and chiral agent in a solvent on the base material surface or double refraction index lay and fixing it.

The chiral agent is added to spirally orient the molecules of the liquid crystal, but it is preferable that the blending quantity of the chiral agent be an amount that is able to obtain a spiral pitch in which the selection reverse phenomenon is in the UV region, because reflected colors of the selected colors are generated by selection reverse phenomenon if the molecules of the liquid crystal take a spiral pitch in the intravital ultraviolet region.

The optical element in the second configuration stacks the layers different in the double refractive index property, so it can more efficiently inhibit the size of retardation of the passing light from changing depending on the location of the person who sees the passing light in recognizing the passing light that passes from a liquid crystal display device if a liquid crystal display device with the optical element is produced.

The optical element of this invention can form coloring layers in the optical element in the first configuration or the second configuration (the third configuration.)

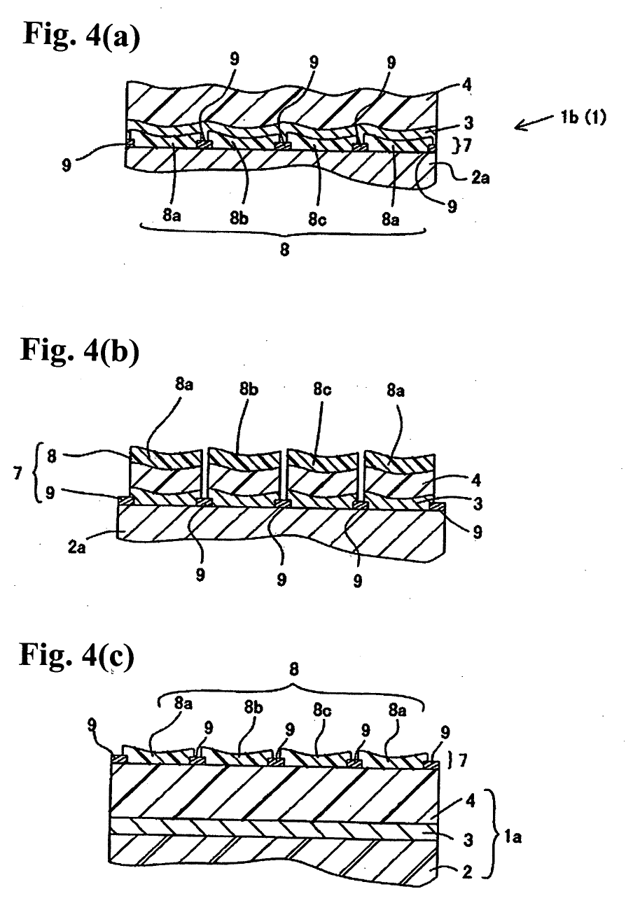

For the optical element in the third configuration, an example of coloring layers formed on the basal plate of the base material as a layer of functionality is described below (FIG. 4(a)).

FIG. 4(a) is a schematic view to show the cross-sectional structure in an embodiment of the optical element in the third configuration.

In the optical element 1b, the basal plate 2b forms a coloring layer 7 on one surface of the base material 2a. The coloring layer 7 consists of the coloring picture element part 8 that transmits the optical wavelength of the specific wavelength region and light interception part 9 (can be called black matrix or BM.)

The coloring picture element part 8 is formed with the coloring picture elements that transmit the light of the waveband of each of the colors, red, green and blue (respectively called red coloring picture element 8a, green coloring picture element 8b and blue coloring picture element 8c), placed in a designated pattern. For the placement form of the red coloring picture element 8a, green coloring picture element 8b, and blue coloring picture element 8c that consists of the coloring picture element part 8, various placement patterns such as a stripe type, mosaic type and triangle type, etc., can be selected. Moreover, instead of these coloring picture elements (8a, 8b, 8c), it is possible to use the coloring picture elements that transmit the light of the waveband of the complementary colors of each of the colors.

The coloring picture element part 8 is formed by patterning the coated film of the dispersion liquid of the coloring material that the coloring material of the coloring picture element is dispersed in the solvent by coloring picture element of each of the colors (8a, 8b, 8c) in a designated shape such as the photolithographic method.

Furthermore, the coloring picture element part 8 can be formed by applying the dispersion liquid of the coloring material in a designated shape by coloring picture element of each of the colors (8a, 8b, 8c) as well as the photolithographic method.

The light interception part 9 inhibits the light leakage from the contiguous coloring picture elements by filling the gap between the coloring picture elements as well as preventing the coloring picture elements (8a, 8b, 8c) from overlapping each other, and moreover, it controls the light degradation, etc., of the active element in the case of using the optical element for the member for liquid crystal layer of the active-matrix-drive system.

Therefore, the light interception part 9 is formed so that the region corresponding to the location where the coloring picture element is placed on the surface of the basal plate 2a is compartmentalized on a plane view by respective coloring picture element (8a, 8b, 8c.) The coloring picture elements (8a, 8b, 8c) of each of the colors are respectively placed to cover the region on the plane view according to the forming location of the region compartmentalized by the light interception part 9 on the surface of the basal plate 2.

The light interception part 9 can be formed by patterning a metal film with a light-blocking effect or light-absorbing effect such as chromium metal thin film and tungsten thin film, etc., on the surface of a basal plate in a designated form. In addition, the light interception part can be formed by printing organic materials such as black plastic, etc., in a designated form.

The coloring layer 7 is not limited to a case of providing plurality of coloring picture elements as described above and can be structured with providing a single coloring picture element. In this case, the coloring layer 7 does not need to provide the light interception part 9.

Moreover, in the optical element in the third configuration, the embodiment in which both of the coloring picture element part 8 and light interception part 9 that make up the coloring layer 7 are provided on the basal plate has been described, but without limiting to this, the optical element can be formed by forming only the light interception part 9 out of the coloring layers on the basal plate, considering it as the base material, stacking the perpendicularly oriented film 3 and the double refraction index layer 4 on this and placing the coloring picture element part 8 on top of this, as shown in FIG. 4(b).

According to the optical element in the third configuration, the double refraction index layer 4 can bloom the coloring layer 7 on the base material 2a. If so, the heat resistance of the coloring picture element part 8 covered by the perpendicularly aligned film 3 and double refraction index layer 4 can be improved as well because the heat resistance of the double refraction index layer 4 is relatively high.

Additionally, when the optical element has the coloring layer, the coloring layer 7 can be stacked on the double refraction index layer 4 of the optical element 1a as shown in FIG. 4(c) as well as the description above.

Subsequently, the member for the liquid crystal layer (can be referred to as the member for the liquid crystal layer in the first configuration) using the optical element in the first configuration or the second configuration is described in detail.

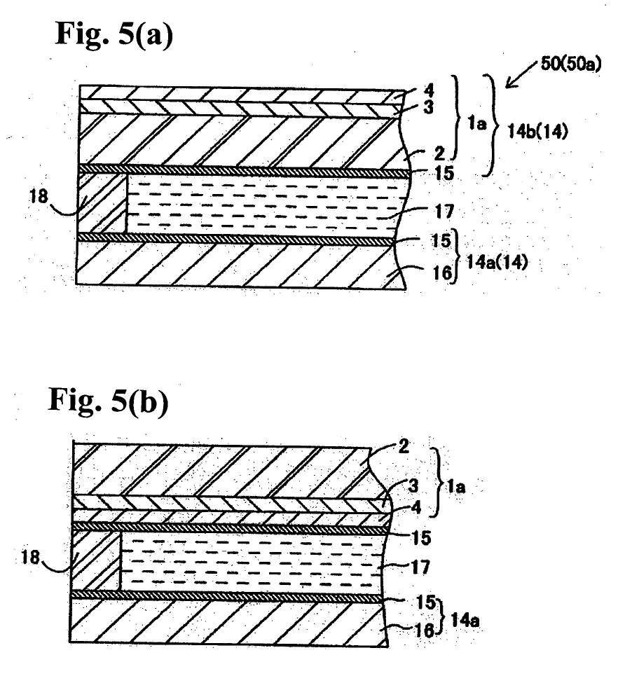

FIGS. 5(a) and 5(b) are schematic views that show an embodiment of the member for the liquid crystal layer according to this invention.

Moreover, for the embodiment of the member for the liquid crystal layer, the case in which the optical element in the first configuration is formed on one side of the stacking structure is described.

As shown in FIG. 5(a), a member for liquid crystal layer 50 (50a) provides two stacking structures 14(14a and 14b) with optical transparency, and a liquid crystal layer 17 is formed between the stacking structures 14a and 14b.

The stacking structure 14a without the optical element formed has a basal plate 16 and an oriented film 15 on the basal plate 16. The stacking structure 14b with the optical element 1a formed has layers (2, 3, 4) forming the optical element 1a and the oriented film 15 and also is placed so that the oriented film 15 and 15 of both of the stacking structure 14a and 14b face each other.

The liquid crystal layer 17 is formed with the liquid crystal encapsulated between the stacking structures 14a and 14b. The encapsulated liquid crystal is accordingly selected.

The liquid crystal layer 17 is formed as shown below. In other words, space compartmentalized between the stacking structures 14a and 14b using a sealing member (thermoset plastic) is formed as well as fixing the stacking structures 14a and 14b placed facing opposite with an space between them using a spacer 18 (for example, spheral spacer or columnar spacer).

Filling a liquid crystal material in this space encapsulates the liquid crystal, and the liquid crystal layer 17 is formed.

The oriented film 15 is a horizontally oriented film to horizontally orient the liquid crystal in the liquid crystal layer 17 formed between the stacking structures 14, or a perpendicularly oriented film to perpendicularly orient the liquid crystal. It is possible to accordingly select to use the horizontally oriented film or perpendicularly oriented film as the oriented film.

The member for liquid crystal layer 50a in the first configuration can produce a liquid crystal display device with relatively high heat resistance with a low cost because it provides the optical element 1a with the double refraction index layer 4 and can make the member for liquid crystal layer thin in width without a film member to control phase differences in a separate body for optical compensation. Moreover, it can further improve the display property because an adhesive member needed to be applied for putting the film member to control phase differences is not necessary, and it facilitates inexpensively providing a transmissive liquid crystal display device that can be used for various purposes.

Furthermore, the forming member for a liquid crystal display device can result by forming the optical element on both of the stacking structures facing each other as well as the embodiment described above.

In addition, this member for a liquid crystal layer can form the optical element 1a so that the double refraction index layer 4 is placed between the basal plate 2 and liquid crystal layer 17 as shown in FIG. 5(b). In doing so, the double refraction index layer 4 is not exposed to the outer surface of the member for the liquid crystal layer, and it prevents exterior acting forces from damaging the double refraction index layer 4 during use.

Subsequently, the member for the liquid crystal layer (called the member for liquid crystal layer in the second configuration) using the optical element in the third configuration is described.

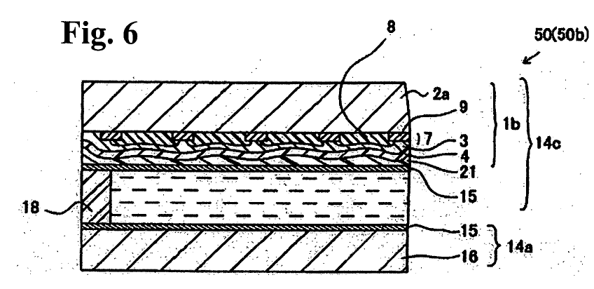

FIG. 6 is a schematic view to show the embodiment of the member for a liquid crystal layer according to a second configuration of this invention.

Furthermore, in this forming member for liquid crystal display device, a case in which the optical element in the third configuration is formed on one of the stacking structures is exemplified.

The member for liquid crystal layer 50b in the second configuration provides two stacking structures 14a and 14c with the optical transparency as well as the member for liquid crystal layer in the first configuration, and has the liquid crystal layer 17 formed between the stacking structure 14a and 14c. The stacking structure 14a without the optical element 1b formed forms the oriented film 15 on the basal plate 16.

In this forming member for liquid crystal display device 50b, the stacking structure 14c with the optical element 1b formed places the oriented film 15 so that the double refraction index layer 4 is placed between this and the basal plate 2a, and the stacking structure 14a and 14c are placed so that the oriented films 15 and 15 face each other.

In the stacking structure 14c, the optical element 1b in the third configuration is formed, and a protective layer 21 to improve and protect the chemical resistance, heat resistance and ITO resistance (indium tin oxide), etc., of the double refraction index layer 4 and to flatten the surface that forms the oriented film 15 by stacking is provided between the optical element 1b and oriented film 15.

The protective layer 21 can be formed with various types of light curable plastic or thermoset plastic such as acrylic plastic, epoxy plastic and polyimide, etc., or a liquid curable plastic.

The protective layer can be formed by a method such as spin coat, printing and photolithographic method, etc., depending on the material. The film thickness of the protective layer 21 is 0.3-5.0 μm, and it is preferably 0.5-3.0 μm.

The forming member for a liquid crystal display device with such structure can be used for the liquid crystal panel of a color display in a reflective liquid crystal display device.

Next, a description is provided regarding the LCD (the LCD of the first embodiment) that uses the LCD members of the first embodiment. In addition, in the examples, cases in which the LCD takes the form of IPS (In-Plane Switching) are explained.

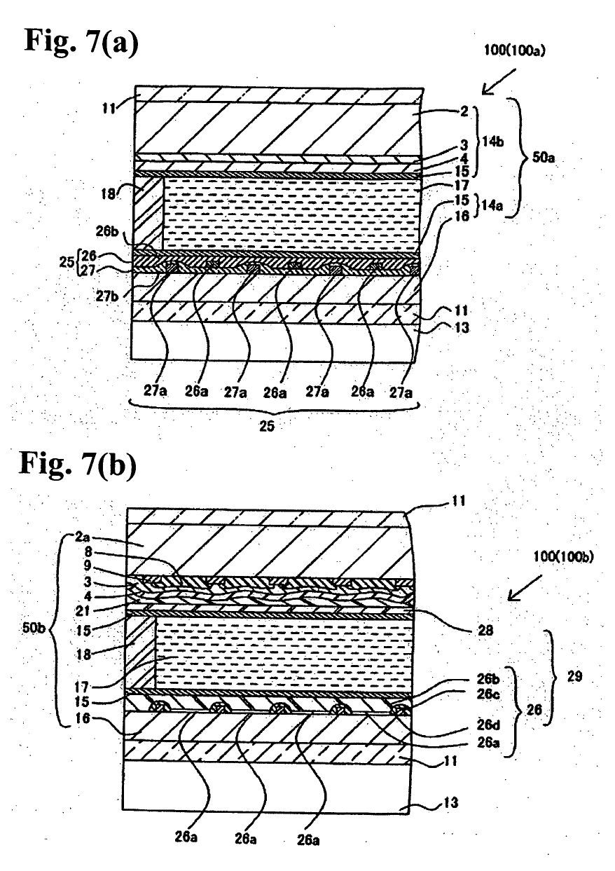

As shown in FIG. 7(a), base plate 16, which in addition to being equipped with deflecting plates 11, 11, consists of laminated structure 14 of LCD member 50a; flat electrode part 25, which has been formed through interposition between orientational films 15; and optical intake part 13 are equipped on both outer surfaces of LCD member 50a.

Deflecting plate 11, 11 is attached to both exterior surfaces of LCD member 50a, but both deflecting plates 11, 11 can be positioned perpendicular to each other or parallel to each other.

Flat electrode part 25 consists of liquid crystal drive electrode part 26 and common electrode part 27, which is electrically compatible with, and faces, liquid crystal drive electrode part 26. Both liquid crystal drive electrode part 26 and common electrode part 27 are positioned between the same base plate 16 and liquid crystal layer 17. Flat electrode part 25 loads the voltage and changes the orientation of the liquid crystal molecules of liquid crystal layer 17.

Liquid crystal drive electrode part 26 is equipped with multiple liquid crystal drive electrodes 26a arranged in matrix format, and planarizing film 26b, which flattens the surface.

The multiple liquid crystal drive electrodes 26a, which are arranged in matrix format, consist of one pixel for each area arranged with individual liquid crystal drive electrodes. Liquid crystal drive electrode 26a, from a planar perspective, cuts longitudinally through most of the center of the corresponding pixels. Liquid crystal drive electrode 26a is formed from transparent electrode materials, such as indium tin oxide (ITO).

Common electrode part 27, along with being equipped with common electrode 27a, which is able to form an electric field between itself and liquid crystal drive electrode 26a, forms a protective layer 27b which coats the common electrode to prevent physical contact with liquid crystal drive electrode part 26. Common electrode 27a ensures correspondence in pairs to each column formed by liquid crystal drive electrodes 26a which have been arranged in a line, and are divided and located on each side of the corresponding pixel column.

Common electrode 27a can be formed from metals such as, for example, tantalum (Ta) and titanium (Ti), etc.

With this LCD 100a, voltage is loaded into the liquid crystal layer for each pixel, and for each pixel, within the light received from optical intake part 13, the transmission amount of light penetrating the deflecting plate is controlled. And so with the LCD, the light which emerges to the exterior by being transmitted through the deflecting plate for each of these pixels, as a whole, forms an image.

LCD 100a of the first embodiment possesses a refractive index layer 4, which has a cross-linked structure improving uniformity of homeotropic alignment in LCD member 50a, so heat resistance is relatively high, and it is even possible to use this in a relatively high-temperature environment such as an in-car LCD. Also, since it is easy to control the production cost of the first refractive index layer 25, it is also possible to provide LCDs at low prices. Also, with conventional LCDs, in order to adjust the narrowness of the viewing angle, the film material (phase difference-control film), which adjusts the phase difference, is adhered separately using an adhesive agent, etc, but with this LCD, there is no longer a need to attach such a film material, and the thickness required for using the adhesive agent is no longer required. Therefore, it is possible to reduce the thickness of devices, as well as to reduce the danger of optical diffusion or absorption due to the adhesive agent.

Furthermore, the LCD (LCD of the second embodiment) using the LCD member of the second embodiment, is explained. In the examples, in particular LCDs in active matrix form are explained. (FIG. 7(b)).

With this LCD 100b, along with the fact that both surfaces of LCD member 50b are equipped with deflecting plates 11, 11, electrode part 29 is interpositioned between base plates 16, 2a, which consists of laminated structures of LCD member 50b, and is equipped with optical intake part 13.

Electrode part 29 consists of picture electrode part 26, which is provided for each pixel, and common electrode part 28, which is shared with, corresponds electrically to and faces each picture electrode part 26. Picture electrode part 26 and common electrode part 28 are set up so that liquid crystal layer 17 can be interpositioned between them.

Picture electrode part 26 arranges picture electrodes 26a in matrix form, so as to correspond, one by one, with each of the color pixels 8a, 8b and 8c, in the film thickness direction, and is formed by being equipped with a switching circuit part (not shown in the Figure), which is installed with picture electrodes, signal wire 26c and scanning line (not shown in the Figure), which are connected electrically to the switching circuit part, an inter-layer insulating film (not shown in the Figure), which electrically separates signal wire 26c and the picture electrodes, and a planarizing film 26b, which coats picture electrode 26a with a protective film 26d and flattens surfaces.

In electrode part 29, scanning line and signal wire 26c are arranged between adjacent picture electrodes, so as to cross each other in a reticular pattern, and the scanning line and signal wire 26c are respectively coated with the insulating film and protective film 26d, in a longitudinal direction.

In addition, the scanning line and the signal wire are formed from metals such as, for example, tantalum (Ta) and titanium (Ti), and the inter-layer insulating film is formed from electrically insulated substances, such as silicon oxides. Also, the protective film is formed from silicon nitrides, etc.

The multiple picture electrodes, which are arranged in matrix form, individually consist of one pixel for each area arranged with picture electrodes. Picture electrodes are formed from transparent electrode material such as indium tin oxide (ITO), etc.

The switching circuit part is arranged to correspond with the picture electrodes, and is connected electrically to the picture electrodes, as well as to the scanning line and the signal wire. The switching circuit part receives a supply of electrical signals from the scanning line and controls the energization state of the signal wire and picture electrodes. Concrete examples of the switching circuit are the 3-terminal type element, such as thin-film transistors, and 2-terminal type element, such as MIM (metal insulator metal).

Common electrode 28 is formed from film, using transparent electrode material such as indium tin oxide (ITO).

As with LCD 100a of the first embodiment, in the case of LCD 100b of the second embodiment, there is no longer a need for using phase difference control film material, and not only is it possible to consider mounting devices, there is also no longer a need for the adhesive agent to adhere to the film material, and it is possible to reduce the concern regarding the diffusion and absorption of light from the adhesion material.

### EXAMPLE 1

Manufacture of Vertically Oriented Film

The vertically oriented film solution (manufactured by JSR Corporation, JALS-2021-R2) is diluted to twice its volume using γ-butyrolactone, producing a film composition liquid. On the glass substrate, which is used as a base material, this film composition liquid is coated, producing a coating film, and the glass substrate on which the coating film is formed is baked for one hour at 180° C., producing the base material in the form of vertically oriented film.

Manufacture of Coating Film for Forming the Refractive Index Layer

As a solution including polyimides, a solution is prepared in which the vertically oriented film solution (manufactured by JSR Corporation, JALS-2021-R2) is diluted to eight times its volume using diethylene glycol dimethyl ether.

As a liquid crystal molecule (polymerization liquid crystal) showing the nematic liquid crystal phase and capable of polymerization, 20 wt part of the compound (except that the value of X is 6) shown in the abovementioned chemical formula (Formula 11), 0.8 wt part of the optical polymerization initiator (manufactured by Nihon-Ciba-Geigy K.K., “IRGACURE 907”), 59.2 wt part of chlorobenzene as a solvent, and 20 wt part of a solution containing polyimides are mixed, producing a refractive index layer composition liquid.

The base material on which the vertically oriented film is formed is placed in the spin coater (manufactured by MIKASA CORPORATION, product name “1H-360S”), spin coating is carried out on the vertically oriented film using the refractive index layer composition liquid, the base material on which the vertically oriented film, which is coated with the refractive index layer composition liquid, is formed and is subjected to a drying process, and the coating film for forming the refractive index layer is produced. However, with this drying process, the base material on which the vertically oriented film, which is coated with the refractive index layer composition liquid, is formed, dries under natural conditions. Natural drying is carried out by leaving it for 5 minutes at room temperature. The coating film for forming the refractive index layer, which is thus produced, is, at the time of drying, about 1.5 μm. In addition, this film is measured using the stylus profilometer (manufactured by Sloan, product name “DEKTAK”).

Formation of Liquid Crystal Homeotropic Alignment State

The base material on which the vertically oriented film, which is coated with the coating film to form the refractive index layer, is formed is subjected to heat at 100° C. for 3 minutes, and it is observed that the liquid crystal molecules within the coating film for forming the refractive index layer form an orientation of a liquid crystal. At this time, the coating film for forming the refractive index layer is observed to go from white and turbid to transparent.

Liquid Crystal Cross-Linked Polymer Reaction

Next, under ambient air conditions, the transparent coating film for forming the refractive index layer is exposed for 10 seconds to ultraviolet rays using an ultraviolet ray emission device with an output of 20 mW/cm² (manufactured by HARRISON TOSHIBA LIGHTING Corp., product name “TOSCURE 751”), and the liquid crystal within the coating film for forming the refractive index layer is made to react with cross-linked polymers, and by fixing the orientation of the liquid crystal molecules, the refractive index layer is formed, and an optical element is obtained.

The optical element obtained, as described below, measures the haze of the optical element.

Measurement of Haze

First, regarding the haze of the optical element, the optical element is installed as an instrument measuring haze, and performs its measurement in compliance with JIS K 7136. In addition, as a haze measurement instrument, it uses the “NDH-2000” manufactured by Nihon Denshoku Kogyosha.

The optical element haze in Example 1 is 0.07.

### COMPARATIVE EXAMPLE 1

The refractive index layer composition liquid is spin coated on to the vertically oriented film, the base material on which the vertically oriented film, which is coated with the refractive index layer composition liquid, is formed is subjected to a drying process, and when the coating film for forming the refractive index layer is produced, through the drying process, the base material on which the vertically oriented film, which is coated with the refractive index layer composition liquid, is formed undergoes decompression drying, and other than that, it is the same as Example 1, producing an optical element.

With regard to the resulting optical element, it is made to be the same as Example 1, with the measurement of haze.

The optical element haze in Comparative Example 1 is 0.9.

### EXAMPLE 2

As a base material, color layers are laminated on to a layer consisting of a glass substrate (base plate layer), and using this optical elements are produced.

The base material is prepared in the manner described below.

Preparing the Coloring Material Dispersion Liquid Used for the Formation of the Color Layers

As a coloring material dispersion liquid of color pixels for black matrix (BM) and red (R), green (G), blue (B), a pigment dispersion type photoresist is used. The pigment dispersion type photoresist uses pigment as a coloring material, and is obtained by adding beads-to the chemical components of the dispersion liquid (including pigment, dispersing agent and solvent), following which centrifugation is carried out for 3 hours using a separator. Subsequently, the dispersion liquid, with the beads removed, and a clear resist formulation (including polymers, monomers, additive agents, initiator and solvents) are mixed. The pigment dispersion type photoresist has the following chemical composition. In addition, the separator used is Paint Shaker (manufactured by ASADA IRON WORKS.CO., LTD.)

(Photoresist for Black Matrix)

black pigment . . . 14.0 wt part

(manufactured by Dainichiseika Color & Chemicals Mfg. Co., Ltd., TM black #9550)

dispersing agent . . . 1.2 wt part

(manufactured by BYK-Chemie, Disperbyk 111)

polymer . . . 2.8 wt part

(manufactured by SHOWA HIGHPOLYMER CO., LTD., VR60)

monomer . . . 3.5 wt part

(manufactured by Sartmer Company, SR399)

additive agent . . . 0.7 wt part

(manufactured by Soken Chemical & Engineering Co., Ltd., L-20)

initiator . . . 1.6 wt part

(2-benzyl-2-dimethylamino-1-(4-morpholinophenyl)-butanone-1)

initiator . . . 0.3 wt part

(4,4′-diethylaminobenzophenone)

initiator . . . 0.1 wt part

(2,4-diethylthioxanthone)

solvent . . . 75.8 wt part

(ethylene glycol monobutyl ethel)

(Red (R) Photoresist for Coloring Pixel)

red pigment . . . 4.8 wt part

(C.I. PR254 (manufactured by Chiba Specialty Chemicals, CROMOPHTAL DPP Red BP))

yellow pigment 1.2 wt part

(C.I. PY139 (manufactured by BASF, Paliotol yellow D1819))

dispersing agent . . . 3.0 wt part

(manufactured by Zeneca, solus pulse 24000)

monomer 4.0 wt part

(manufactured by Sartmer Company, SR399)

polymer 1 . . . 5.0 wt part

initiator . . . 1.4 wt part

(manufactured by Nihon Ciba-Geigy K.K., IRGACURE 907)

initiator . . . 0.6 wt part

(2,2′-bis(o-chlorophenyl)-4,5,4′,5′-tetraphenyl-1,2′-biim idazole)

solvent . . . 80.0 wt part

(propylene glycol monomethyl ether acetate

(Green (G) Photoresist for Coloring Pixel)

green pigment . . . 3.7 wt part

(C.I. PG7 (manufactured by Dainichiseika Color & Chemicals Mfg.Co., Ltd., SEIKAFAST green 5316P))

yellow pigment . . . 2.3 wt part

(C.I. PY139 (manufactured by BASF, Paliotol yellow D1819))

dispersing agent . . . 3.0 wt part

(manufactured by Zeneca, Solsparse 24000)

monomer . . . 4.0 wt part

(manufactured by Sartmer Company, SR399)

polymer 1 . . . 5.0 wt part

initiator . . . 1.4 wt part

(manufactured by Nihon Chiba-Geigy K.K., IRGACURE 907)

initiator . . . 0.6 wt part

(2,2′-bis(o-chlorophenyl)-4,5,4′,5′-tetraphenyl-1,2′-biimidazole)

solvent . . . 80.0 wt part

(propylene glycol monomethyl ether acetate)

(Blue (B) Photoresist for Coloring Pixel)

blue pigment . . . 4.6 wt part

(C.I. PB15:6 (manufactured by BASF, Heliogen blue L6700F))

purple pigment . . . 1.4 wt part

(C.I. PV23 (manufactured by Clariant, Hostaperm RL-NF))

pigment derivative . . . 0.6 wt part

(manufactured by Zeneca, Solsparse 12000)

dispersing agent . . . 2.4 wt part

(manufactured by Zeneca, Solsparse 24000)

monomer . . . 4.0 wt part

(manufactured by Sartmer Company, SR399)

polymer 1 . . . 5.0 wt part

initiator . . . 1.4 wt part

(manufactured by Nihon Ciba-Geigy K.K., IRGACURE 907)

initiator . . . 0.6 wt part

(2,2′-bis(o-chlorophenyl)-4,5,4′,5′-tetraphenyl-1,2-biimi dazole)

solvent 80.0 wt part

(propylene glycol monomethyl ether acetate

In addition, the abovementioned polymer 1 is one in which 16.9 mol % of 2-methacryloyloxyethyl isocyanate is added to 100 mol % copolymer of benzyl methacrylate:styrene:acrylic acid:2-hydroxyethyl methacrylate=15.6:37.0:30.5:16.9 (mole ratio), where the weight-average molecular weight is 42500.

Formation of Color Layers

The glass substrate is prepared as a base plate for carrying out the cleaning process (manufactured by Corning Incorporated, “1737”), and on the upper surface of this glass substrate, as described below, for each color, the coloring material dispersion liquid is coated, and the color layer is laminated onto the base plate.

First, the photoresist for BM, prepared as described above, is spin coated on to the glass substrate at a thickness of 1.2 μm, and pre-baked under conditions of 90° C. for 3 minutes, and made to undergo exposure using a mask formed in a prescribed pattern, (100 mJ/cm²), and after continuing to bake using 0.05% KOH aqueous solution, is subjected to spraying for 60 seconds, after which post-baking takes place at 200° C., 30 minutes, producing a BM base plate on which BM has been formed.

Next, red (R) pigment dispersion type photoresist is spin coated on to the abovementioned BM base plate, and pre-baked under conditions of 80° C., 5 minutes, and using a photomask with a prescribed pattern, undergoes alignment exposure (300 mJ/cm²). Furthermore, after spraying for 60 seconds using a 0.1% KOH aqueous solution, a film of 2.8 μm is obtained at the prescribed locations and the red(R) color pixel pattern is formed.

Continuing, using the same method and conditions as the abovementioned red (R) color pixel pattern a 2.6 μm green (G) color pixel pattern is formed.

Furthermore, using the same method and conditions as the abovementioned red (R) color pixel pattern a 2.3 μm blue (B) color pixel pattern is formed.

In this manner, on the glass substrate, color layers are formed from BM, red color pixel, green color pixel, and blue color pixels, and the base material for forming color layers on the base plate layer is obtained.

A film composition liquid forming the vertically oriented film prepared in the same manner as in Example 1 is coated on the color layers of the obtained base material, and the vertically oriented film is formed, and the base material for forming the vertically oriented film is obtained.

Next, a refractive index layer composition liquid is prepared in the same manner as in Example 1. Then, the base material for forming the vertically oriented film is placed in the spin coater (manufactured by MIKASA, product name “1H-360S”), and the refractive index layer composition liquid is spin coated on to the vertically oriented film, producing the coating film for forming the refractive index layer. The resulting coating film for forming the refractive index layer is whitened. The coating film is thus whitened. Furthermore, the produced coating film for forming the refractive index layer, during drying is about 1.0 μm. In addition, this film is measured using a stylus profilometer (manufactured by Sloan, product name “DEKTAK”).

With respect to the base material on which the vertically oriented film, which is formed by the coating film for forming the refractive index layer, is formed, as in Example 1, formation in a liquid crystal homeotropic alignment, and a reaction of liquid crystal cross-linked polymers is carried out, and an optical element is obtained.

Regarding this optical element, as shown below, the contrast performance is measured.

First, using this optical element, the LCD is produced as shown in FIG. 7(b). In this LCD, light transmitted through the liquid crystal layer is formed to easily permit transmission of light (light state) or not to easily permit transmission of light (dark state), and the light state/dark state measures the brightness of the light transmitted out through the liquid crystal layer and deflecting plates. Also, the values obtained by taking a ratio of the brightness in the light state and the brightness in the dark state, serve as an index of the contrast performance.

The optical element of, Example 2 has a contrast performance of 1200.

### COMPARATIVE EXAMPLE 2

The refractive index layer composition liquid is spin coated on to the vertically oriented film, and subjected to drying on the base material on which the vertically oriented film, which is coated with the refractive index layer composition liquid is formed. When the coating film for the formation of the refractive index layer is produced, through this drying process, the base material for forming the lamination orientational film coated with the refractive index layer composition liquid undergoes decompression drying, apart from which, everything is the same as in Example 2, and the optical elements are produced.

As with Example 2, measurement of the contrast performance of the resulting optical element is carried out.

The contrast performance of the optical element in Example 2 is 700.

The disclosure of Japanese Patent Application No. 2005-105513 filed on Mar. 31, 2005, is incorporated herein.

What is claimed is:

1. An optical element comprising:
a substrate having an optically transparent base plate; and
a refractive functional layer capable of refracting light provided on the substrate, the refractive functional layer comprising liquid crystal molecules fixed in a homeotropic alignment, and
the optical element having a haze of 0.1 or less.

2. An optical element according to claim 1, wherein the refractive functional layer comprises
a vertically oriented film capable of fixing the liquid crystal molecules in the homeotropic alignment, and
a refractive index layer provided on the vertically oriented film, the refractive index layer capable of fixing cross-linked liquid crystal molecules, and having a polymerizable base at a tip in homeotropic alignment.

3. An optical element according to claim 2, wherein the refractive index layer fixes cross-linked liquid crystal molecules in homeotropic alignment, after having dried, in the air, the base plate, which has been coated with a refractive index layer composition liquid containing the liquid crystal molecules.

4. An optical element according to claim 1, further comprising a color layer with a color pixel part, the color layer being disposed in at least one substrate surface at the side where the refractive functional layer is formed or not formed.

5. A liquid crystal display member comprising:
a first and a second substrate each comprising a layer having optical transparency; and
a liquid crystal layer disposed between the first and the second substrates,
wherein one of the first and the second substrates comprises the optical element according to claim 1.

6. A liquid crystal display member according to claim 5, wherein the refractive functional layer is disposed between the substrate and the liquid crystal layer.

7. A liquid crystal display member according to claim 5, wherein the refractive functional layer comprises
a vertically oriented film capable of fixing the liquid crystal molecules in the homeotropic alignment, and
a refractive index layer provided on the vertically oriented film, the refractive index layer capable of fixing cross-linked liquid crystal molecules, and having a polymerizable base at a tip in homeotropic alignment.

8. A liquid crystal display member according to claim 5, wherein the refractive index layer fixes cross-linked liquid crystal molecules in homeotropic alignment, after having dried, in the air, the base plate, which has been coated with a refractive index layer composition liquid containing the liquid crystal molecules.

9. A liquid crystal display member according to claim 5, further comprising a color layer with a color pixel part, the color layer being disposed in at least one substrate surface at the side where the refractive functional layer is formed or not formed.

10. A liquid crystal display comprising:
the liquid crystal display member according to claim 5;
a layer comprising an electrode part capable of applying a voltage and changing an orientation of the liquid crystal layer; and
a first and a second polarizing plate layer each disposed, respectively, on a first side and a second side of the liquid crystal layer.

11. A liquid crystal display according to claim 10, wherein the refractive functional layer is disposed between the substrate and the liquid crystal layer.

12. A liquid crystal display according to claim 10, wherein the refractive functional layer comprises
a vertically oriented film capable of fixing the liquid crystal molecules in the homeotropic alignment, and
a refractive index layer provided on the vertically oriented film, the refractive index layer capable of fixing cross-linked liquid crystal molecules, and having a polymerizable base at a tip in homeotropic alignment.

13. A liquid crystal display according to claim 10, wherein the refractive index layer fixes cross-linked liquid crystal molecules in homeotropic alignment, after having dried, in the air, the base plate, which has been coated with a refractive index layer composition liquid containing the liquid crystal molecules.

14. A liquid crystal display according to claim 10, further comprising a color layer with a color pixel part, the color layer being disposed one substrate surface at the side where the refractive functional layer is formed or not formed.
